(19) United States
(12) Patent Application Publication
(10) Pub. No.: US 2006/0036410 A1
(43) Pub. Date: Feb. 16, 2006

(54) System and method for fabric hand evaluation

(76) Inventor: Ning Pan, El Macero, CA (US)

Correspondence Address: BAY AREA INTELLECTUAL PROPERTY GROUP, LLC, PO BOX 210459, SAN FRANCISCO, CA, 94121-0459, US

(21) Appl. No.: 11/189,965

(22) Filed: Jul. 25, 2005

Related U.S. Application Data
(60) Provisional application No. 60/592,159, filed on Jul. 29, 2004.

(51) Int. Cl. G06F 17/00

(52) U.S. Cl. 702/189

(57) ABSTRACT

Evaluation of a material such as a fabric is described by way of acquiring initial sensory response data from the material, performing an Eigen-analysis on the data, extracting at least one feature from the Eigen-analysis; and ranking the material based on the at least one feature. The capability of physiological scaling is provided for use as a basis for the ranking step. In some applications of the present invention the material is a fabric, and some embodiments thereof further include the capability of evaluating the fabric for wrinkle recovery ability and/or for fabric drape-ability.

### CROSS-REFERENCE TO RELATED APPLICATIONS

The present Utility patent application claims priority benefit of the U.S. provisional application for patent No. 60/592,159 filed on Jul. 29, 2004 under 35 U.S.C. 119(e).

### FEDERALLY SPONSORED PRESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to fabric hand evaluation devices. More particularly, the invention relates to fabric hand evaluation devices implementing pattern recognition and fabric fingerprinting techniques.

### BACKGROUND OF THE INVENTION

Fabric hand has long been considered as one of the most important quality attributes for fibrous products including paper, woven and knitted fabrics, non-woven, and other products in contact with human skin. The word “fabric” here is a general term representing any flat sheets made of fibers. There exist in the prior art several slightly different definitions for fabric hand. In general, however, fabric hand is considered as human's tactile sensory response towards fabric, which involves not only the physical, but also the physiological, and psychological and social factors; this very fact complicates the process of fabric hand evaluation tremendously.

The importance of this fabric quality perceived through tactile sense is well known. It is hard to image a consumer would buy a textile product without touching it, and a poor hand is often the reason why a consumer rejects a product; one such well-known example is polyester fiber; it acquired such a bad image at its early stage mainly because of the poor fabric hand. Success of any new fiber, new finish or new textile product will be largely dependent on the acceptance of fabric hand. However, assessment of this quality attribute up to now is still largely relied on human tactile sensory judgment, which in many cases is not reliable. Furthermore, while it is common knowledge to textile scientists that the physical aspect of the fabric hand is attributed to the properties of the fabric, there is no approach by which this aspect can be measured directly. This is mainly due to the fact that even the physical fabric hand is basically a reflection of the overall fabric quality, attributed to many individual fabric properties.

The first attempt to study the phenomenon of fabric hand was initiated by Binns in 1926 by employing people with a wide range of backgrounds in order to investigate the hand characteristics among different groups and individuals. Because of the importance of fabric hand, there have been at least four well-attended international conferences (1981, Japan; 1983, Australia; 1985, Japan; 1988, Hong Kong) exclusively devoted to this subject, pushing forward significantly the research in this area.

As stated by Brand (see Brand, R. H., “Measurement of fabric aesthetics: Analysis of aesthetic components”, Textile Res. J., V34; 1964) stated, “The aesthetic concepts [of fabrics] are basically people's preferences and should be evaluated subjectively by people”. This apparent common-sense approach immediately runs into difficulties, however, such as finding the most appropriate judges: experts or untrained consumers? There is difficulty with the communication between judges, the low assessment sensitivity and effect of personal preference. The conclusion has been that a reliable sensory evaluation of fabric hand is possible, but obviously the method does not facilitate rapid development of textile products. An instrumental approach thus becomes a desirable.

Perice (see Peice, F T., The “hand” of cloth as a measurable quantity, Textile Research Journal, V.63,T377, 1930) in 1930 first proposed to evaluate fabric hand based on the data of physical measurement. Since then, there have been several attempts to use instruments measuring fabric hand. The whole effort climaxed in 1970 when Kawabata and his co-workers in Japan developed a KES-FB system (see Kawabata S., Niwa M., Ito, K,and Nitta, M., Application of Objective Measurement to Clothing Manufacture, International Journal of Clothing Science and Technology, 2, 18; 1990) for fabric hand evaluation. This entire system is composed of four instruments, each measuring a few different fabric properties such as tensile and shearing; bending; compression; and surface properties at low stress, simulating the forces encountered when handling a fabric. The fundamental principle of this system is then to connect the measured 16 mechanical properties of a fabric directly to its Japanese hand preference through multivariate statistical regression analysis. However, because of the subjectivity of preference, this system failed to offer satisfying solution for fabric hand assessment in countries other than Japan, and there are still many known problems associated with this system. In 1990, several scientists in Australia built another instrument system called FAST system that is basically a simplified version of the Japanese KES-FB system, and therefore share the same problems from it. Besides, both systems are time consuming with high cost. Successful resolution of the fabric hand evaluation problem will not only provide a powerful quality assurance method for textile industry, it will also offer solutions to other consumer product questions, where product quality relies on sensory evaluation, for instance, the smell of perfume, taste of food, softness of pillow etc. Further it has some implications or may shed light on our understanding of relationship between physical stimuli and physiological, psychological and social response.

In view of the foregoing, there is a need for improved techniques for fabric hand evaluation. To achieve the forgoing and other objects and in accordance with the purpose of the invention, a variety of improved

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates an exemplary outward structure of an instrument for fabric hand evaluation, in accordance with an embodiment of the present invention. FIG. 1B illustrates a general system level block diagram of the exemplary system, which is suitable to implement the preferred embodiment. FIG. 1C illustrates an exemplary Graphic User Interface (GUI) of the associated software system, in accordance with an embodiment of the present invention;

FIG. 2 illustrates an example of a more detailed system diagram for the fabric hand evaluation instrument, in accordance with an embodiment of the present invention;

FIG. 3 shows an exemplary mechanical measurement device, in accordance with an embodiment of the present invention;

FIG. 4 illustrates a graph of four sample force-displacement curves generated by the instrument and collected by an-industry standard RS-323 computer serial port, in accordance with an embodiment of the present invention;

FIG. 5 illustrates an exemplary computer data analysis flow chart, in accordance with a preferred embodiment of the present invention;

FIG. 6 illustrates exemplary fingerprints of different fabrics created by the fabric hand evaluation instrument, in accordance with an embodiment of the present invention; and

FIG. 7 illustrates atypical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of fabric hand evaluation techniques are described.

Some embodiments of the present invention are described that provide a method, apparatus, and computer program product for evaluation of a material that include the capability of acquiring sensory data sensed from the material, performing an Eigen-analysis on the sensory data, extracting at least one feature from the Eigen-analysis; and ranking the material based on the at least one feature.

Other embodiments further include that the capability of pre-processing the acquired initial data, the pre-processed data being used by the Eigen-analysis instead of the initial data. Yet other embodiments further include the capability of establishing a physiological scaling scheme that is used as a basis for the ranking step.

In some applications of the present invention the material is a fabric, wherein some embodiments thereof further include the capability of evaluating the fabric for wrinkle recovery ability and/or for fabric drape-ability.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

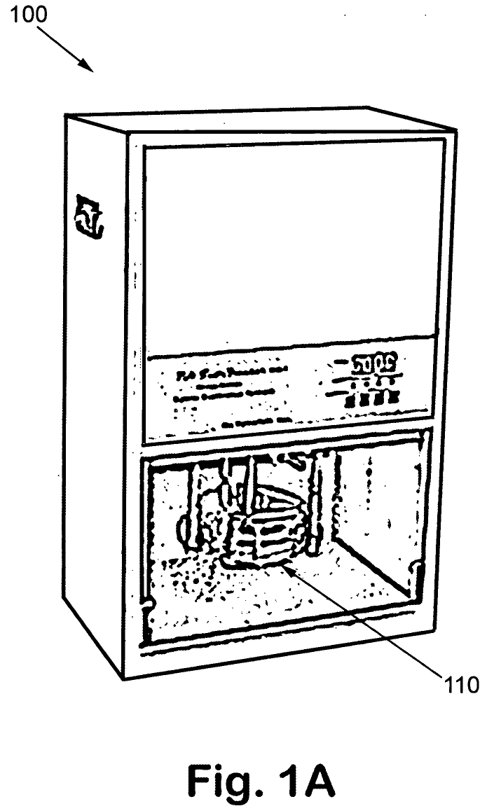

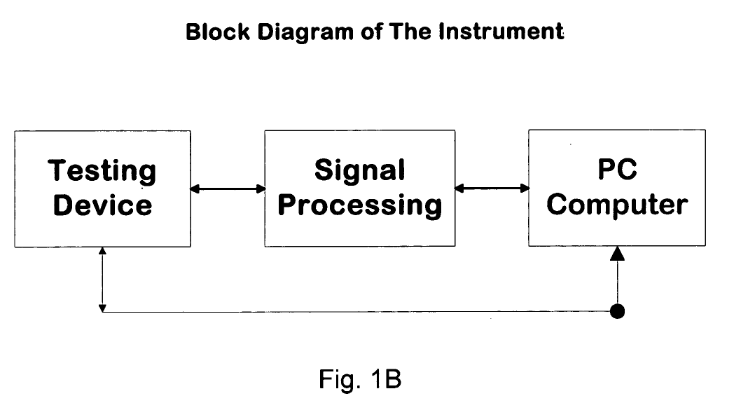

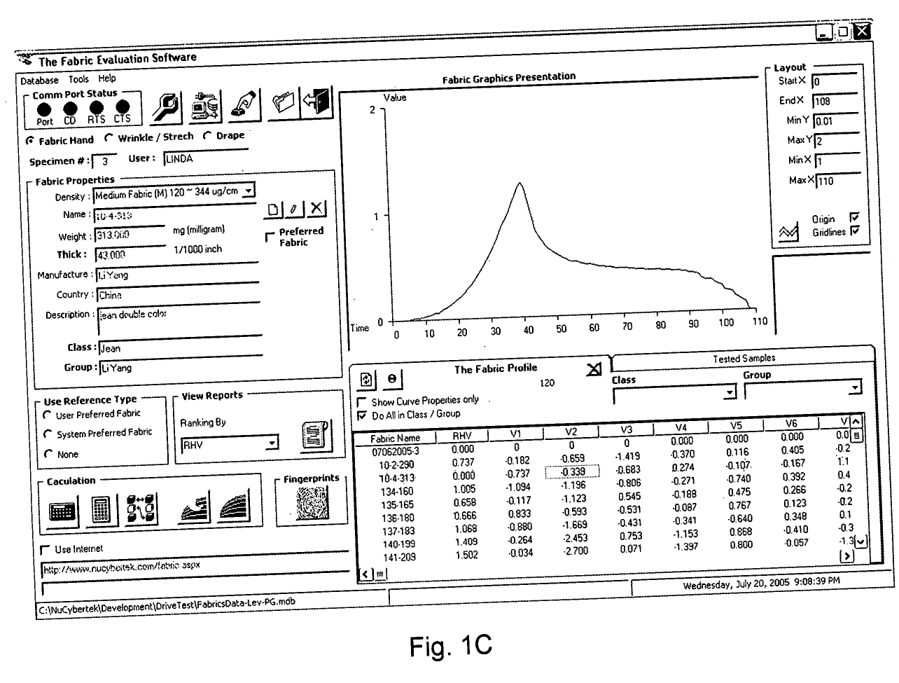

FIG. 1A illustrates an exemplary outward structure of an instrument 100 for fabric hand evaluation, in accordance with an embodiment of the present invention. In the present embodiment, the instrument is suitable to implement known pattern recognition and fabric fingerprinting techniques. A preferred embodiment of the present invention carries out the pattern recognition and fabric fingerprinting techniques for fabric hand evaluation. Shown in the Figure is an exemplary mechanical measurement device 110 which carries out the fabric hand sensing as described in more detail below. FIG. 1B illustrates a general system level block diagram of the exemplary system, which is suitable to implement the preferred embodiment. The present embodiment comprises a specialized measurement, or testing device, which is connected via a signal-processing interface to a general-purpose computer for operation control and data analysis. FIG. 1C illustrates an exemplary Graphic User Interface (GUI) of the associated software system, in accordance with an embodiment of the present invention. Those skilled in the art, in light of the present teachings and known techniques, will readily recognize alternate and suitable outward structures, computer platforms (e.g., non-PC implementations), and GUIs.

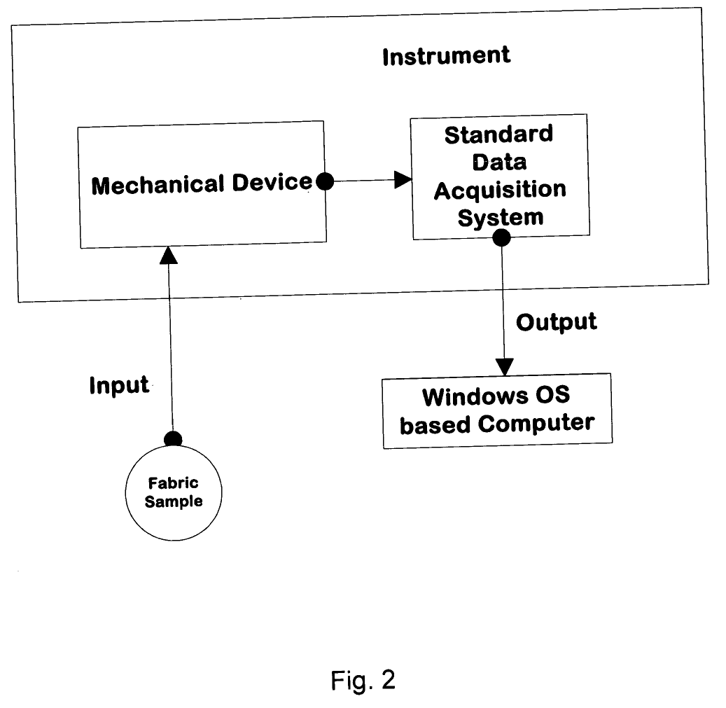

FIG. 2 illustrates an example of a more detailed system diagram for the fabric hand evaluation instrument, in accordance with an embodiment of the present invention. In the present embodiment, the detailed system includes, but is not limited to an electrical motor system, a data acquisition system, a computational module, and a mechanical device. The fabric sample tested by the system could be a piece of fabric, by way of example and not limitation, which is circle-shaped and has area of 100 cm². The electric motor driven system is comprised of a control circuit, a driven mechanism and a motor. In the present embodiment, the data acquisition system processes the electric signal from a strain gauge through amplifying, filtering and AD conversion to finally feed the digital data into the computer. The computer, via an installed algorithm module, processes the data through normalization, pattern recognition and feature selection, and then output the results in terms of the fabric extraction curves and fabric features such as stiffness, smoothness, softness, etc. The results are preferably given in the form of a numerical ranking based on a user-provided standard sample and a fingerprint profile for the fabric. However, those skilled in the art will recognize alternative and suitable scoring systems in light of the teachings of the present invention. For example, without limitation, fabrics can be evaluated by comparing the fabric extraction curves, or by curves plotted using the fabric features such as stiffness, smoothness, softness, or be ranked numerically according to the values of such fabric features individually or collectively as described below.

In the present embodiment, the testing is begun when the computer sends out a signal to trigger the electric motor driven system. The motor then drives a sensing rod to push the fabric sample down through a nozzle and meanwhile a set of force data generated by a transducer is converted to a digital signal by the data acquisition system and fed into the computer. In the present embodiment, the mechanical device includes, but is not limited to, a fabric sample holder, a sensing, system, and an instrument case. The instrument case embodies all the individual parts and provides fixtures and supports to some parts as needed. The parts enclosed in the instrument case include, but are not limited to, the electric motor driven system, the data acquisition system, an internal lighting and a computer.

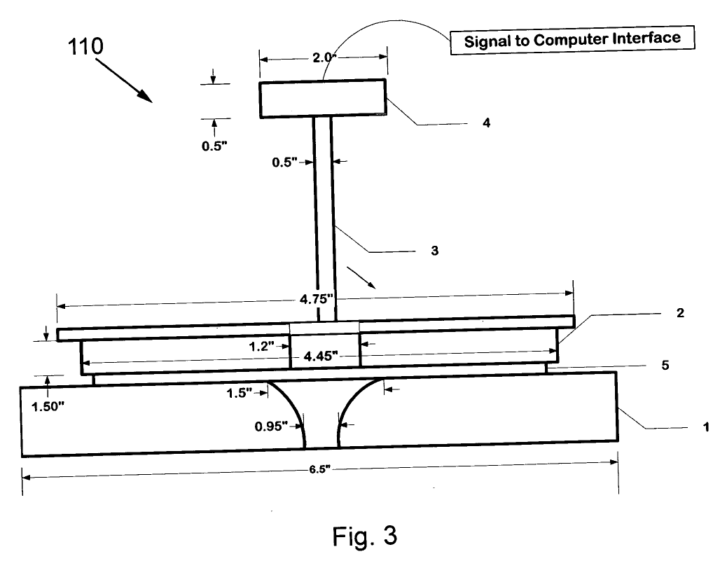

FIG. 3 shows a detailed view of an exemplary mechanical measurement device 110, in accordance with an embodiment of the present invention. It should be appreciated that all measurements shown are completely exemplary and those skilled in the art will readily recognize, in light the present teachings and of known techniques, the proper configuration for the particular application. Mechanical measurement device 110 is preferably comprised of a fabric holder and a sensing system. In the present embodiment, the fabric holder is comprised of a metal nozzle 1 with a specially designed shape, a support plate with three metal rods connected to the roof of the instrument case and a weight plate 2. The shape and size of the nozzle are preferably specially designed to assure a smooth passage of the fabric sample during testing while generating a signal of proper ranges, also for easy making. Other sizes and shapes will work so long as such a smooth test and proper signal can be achieved. Metal is chosen for its high abrasion resistance and hardness, other materials durable enough for the needs of the particular application will be workable as well. The weight of weight plate 2 is preferably chosen based on the fabric to be tested. Both the support plate and weight plate 2 have an opening in the center. A fabric sample 5 lies flat on top of a supporting track plate, which has tracks on both sides of the bottom face which fit into corresponding grooves on the top face of the support plate. In the preferred embodiment; the tracks on the supporting track plate would be 0.3″ deep for space saving while facilitating easy operations of mounting and un-mounting the testing fabric specimens, but other track depths may also be suitable. In the present embodiment, fabric sample 5 is a piece of fabric, which is circle shaped and has an area of 100 cm². Circular shape was chosen in the present example for easy preparing using the existing sample cutter, and uniform stress and elongation on the fabric during testing. Weight plate 2 is put on top of fabric sample 5 to exert proper pressure to the fabric during the testing process. Weight plate 2 is a circle shaped metal plate. Circular shape was chosen for easy manufacturing, storage and handling. Metal nozzle 1 is set on the supporting track plate for fabric extraction. Metal nozzle 1 is set at the middle of the supporting track plate so it can be pulled out and pushed back smoothly just like a draw to mount fabric sample 5. In the present embodiment, the sensing system is comprised of a sensing rod 3 coaxially centered with nozzle 1 with the upper end of sensing rod 3 fixed to a strain gauge transducer 4 that in turn is connected to a beam that is supported by the frame of the instrument. In the preferred embodiment, the up and down movement of sensing rod 3 is controlled by a purchased electrical motor at the speed of 60 turns/sec for many applications. Generally, small variations of the motor speed will not affect the final results. Strain gauge transducer 4 is connected with sensing rod 3 to generate a force-electric signal while sensing rod 3 pushes fabric sample 5 downward through nozzle 1. Pushing the fabric sample down through the nozzle while maintaining the pressure on the fabric sample via the Weight plate 2 with carefully determined weight during the testing process helps to maintain accuracy, repeatability and resolution of the testing results. All other aspects of the presently described apparatus are secondary and may be readily configured, in light of the present teachings, by those skilled in the art to suite the needs of the particular application.

In the present embodiment, implementing a typical testing process includes the following steps. The fabric sample 5 is first mounted to the instrument. To mount the fabric sample, first pull out the supporting track plate where metal nozzle 1 is set, and lay fabric sample 5 on the plate, cover it by weight plate 2 to hold fabric sample 5 in place during the downward movement of sensing rod 3, and then push the whole set back. Then, by pressing a key on the computer, a trigger signal is sent to the motor in the instrument to push sensing rod 3 downward to start the measurement process, thereby, enabling the collection of, among other data, force-displacement data. A force-displacement curve is preferably plotted on the computer screen. In the present example, using commonly available system components, the measurement takes about one minute, and the data are collected into a computer database ready for fabric hand analysis.

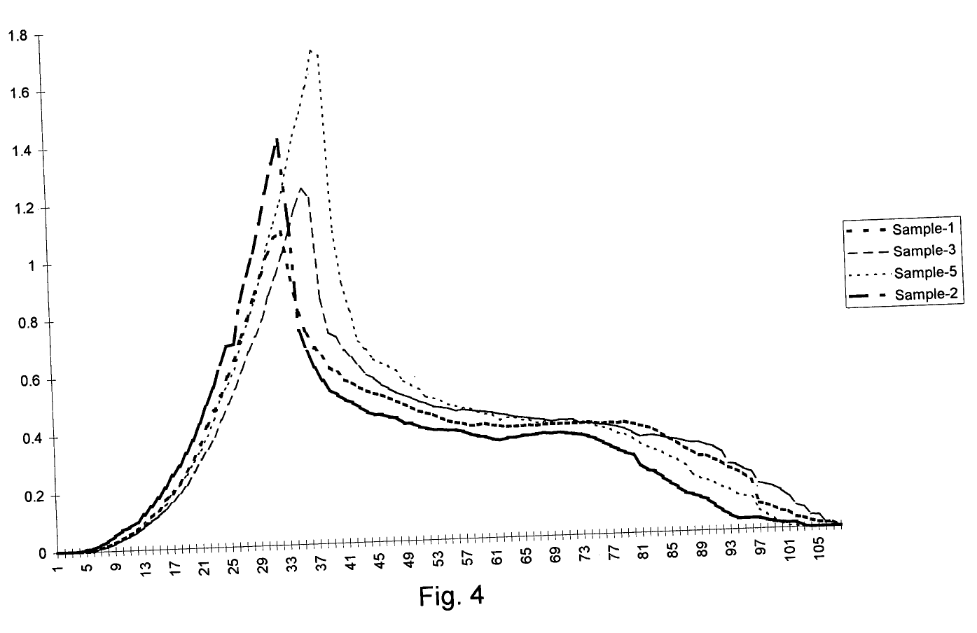

FIG. 4 illustrates a graph of four exemplary sample force-displacement curves generated by the instrument of FIG. 3 and collected by an industry standard RS-323 computer serial port, in accordance with an embodiment of the present invention. Table 1 illustrates the testing results corresponding to the four fabric samples 1, 2, 3, 4 listed in FIG. 4.

TABLE I
Samples Test Result

| Ranking by Stiffness Value | Sample Name | Stiffness Value |
|---|---|---|
| 1 | Sample-2 | 1.446541 |
| 2 | Sample-4 | 1.465424 |
| 3 | Sample-3 | 1.667709 |
| 4 | Sample-1 | 1.795972 |
| Ranking by Smoothness Value | Sample Name | Smoothness Value |
| 1 | Sample-2 | 1.156883 |
| 2 | Sample-4 | 1.318238 |
| 3 | Sample-1 | 1.588017 |
| 4 | Sample-3 | 1.91646 |
| Ranking by Softness Value | Sample Name | Softness Value |
| 1 | Sample-1 | 2.007321 |
| 2 | Sample-3 | 2.090356 |
| 3 | Sample-2 | 2.585388 |
| 4 | Sample-4 | 2.792249 |

Set Sample-3 as the User Preferred Fabric (s = 3)

| Overall Ranking | Sample Name | RH Index |
|---|---|---|
| 1 | Sample-3 | 0 |
| 2 | Sample-1 | 0.25052 |
| 3 | Sample-4 | 0.508836 |
| 4 | Sample-2 | 0.64758 |

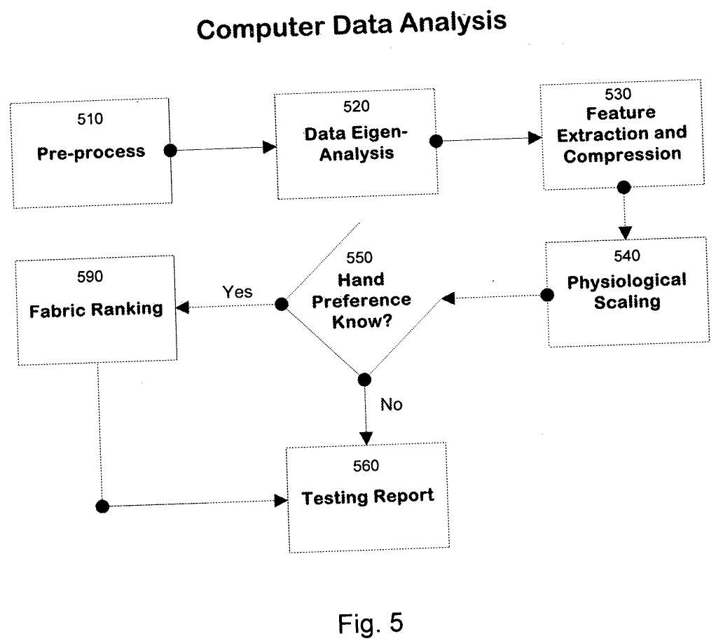

FIG. 5 illustrates an exemplary computer data analysis flow chart of a general approach for fabric hand analysis, in accordance with a preferred embodiment of the present invention. The process begins at Step 510 by performing what is referred to as “pre-processing”. Depending on the particular application, pre-processing may include, but is not limited to, data verification for abnormality, data smoothing and statistical data normalization. In some applications, the pre-processing step may not be needed and thereby skipped. Then an Eigen-analysis on the pre-processed data is performed at Step 520, as will be described in some detail below. Among other results, the Eigen-analysis produces Eigenvalues and Eigenvectors which may be used to determine the optimal feature centric axes by which to better perform feature extraction, or selection, and compression at Step 530, as will be described in some detail below. Once the desired features are extracted, a physiological scaling process is performed at Step 540. Physiological scaling may be understood to mean any ranking or rating schemes developed and used in physiological sensory evaluation, conceptually similar, for example, without limitation, to those used in wine tasting, perfume assessing and fabric hand evaluations. If at step 560 a hand preference is known, as described in some detail below, then the process proceeds to generate a fabric ranking, which is also described in some detail below, at Step 570 and thereafter produces a testing report at Step 580; otherwise, fabric ranking is skipped, and the process proceeds directly to producing the testing report at Step 580.

During the testing process, when the fabric sample is pushed through the nozzle, each sample is deformed under a complex yet low stress state including tensile, shearing and bending as well as frictional actions, and other known analysis techniques similar to the stress states that occur under typical human handling of a fabric. The information related to fabric hand is reflected by a load-displacement extraction curve. It should be noted that known prior attempts at fabric hand analysis only made use of one feature of the present curve, such as, without limitation, the peak or the slope at a point, and discarded the rest of the information, if it was ever gathered. The present embodiment identifies and extracts substantially all of the needed information and classifies it in terms of known fabric attributes.

Each collected curve or pattern is in a form of a discrete data set X of n dimension inside the computer, which is known to contain all the information about fabric hand:
X=(X₁,X₂ . . . Xₙ) (1)
In this n-dimension data space, there exists information redundancy or correlation. In other words, not all the data points in the set X are useful. Then the well known Karhunen-Loeve transformation is used to complete the so-called feature selection procedure from the data set X. It is well known that by means of the present feature selection technique all the useful information contained in the data set X (e.g., in the extraction curve) can be represented by a new data set F with fewer features without any significant information loss or superfluous elements. In this way, the present feature selection approach may also be thought of as feature compression in that a mathematical transformation of the data from a higher dimensional space to a lower one by eliminating the redundant components so as to condense the information and reduce the dimensions of the original data. For each data set X in this case, there are a total of p<n features named F₁ to Fₚ:
F=XR=(F₁, F₂ . . . Fₚ) (2)
Where R is a matrix made of the first p eigenvectors of the covariance matrix V of X Having now obtained all the properties in terms of these p features, the remaining problem is to determine the correspondence between these features and the fabric properties, which is known to those skilled in the art. The correlation analysis is used to identify the physical meaning of the p=8 features in terms fabric properties. Next, a series fabric specimen of identical origin is established, but having different known properties. So, these fabrics may be used to calibrate the p features. These selected and calibrated features can then be printed out as fabric hand values such as the stiffness, softness, and smoothness etc. These selected features have been proved to be orthogonal or uncorrelated with each other; in other words, they each reflect a different aspect of fabric hand. Known attempts fail to achieve this result.

For each fabric tested, and in the case where users (or others) are able to provide a reference sample, an overall hand value—which can be defined as a distance between preferred sample and the testing sample—is calculated as the ranking of the fabric hand relative to the user-specified one. This distance obviously can specify the difference in fabric hand, and any other fabric attributes determined by the mechanical properties such as fabric elasticity, fabric stretch-ability, fabric wrinkle recovery and fabric drape-ability, between the two fabrics. This weighed Euclidian distance is our objective measure in between the physical stimuli and human sense. The relative importance of the selected features is known to be represented by their corresponding eigenvalue Cᵢ. So the ratio,

$$\frac{{C}_{i}}{{\sum }_{k = 1}^{n} {C}_{k}} = \frac{{C}_{i}}{tr V} \qquad ( 3 )$$

where V is the covariance matrix of X and

$$tr V = {\sum }_{k = 1}^{n} {C}_{k}$$

is the trace of V, actually indicates the weight or importance of the component Fᵢ. Once the weight of each feature is known, a weighed Euclidian Distance can defined, termed Relative Hand (pH) value here:
RH={square root over ((Σᵢ₌₁^{p}Wᵢ(Fᵢ−Fᵢₛ)²))} (4)
where

$${W}_{i} = \frac{{C}_{i}}{tr V}$$

is the weight of the component Fᵢ. If either from the past experience or from customer request, a standard fabric s which represents a desired fabric preference is available, then RH values in Table 1 calculated from Eq. (4) relative to fabric s will provide us a fabric evaluation result corresponding to this given preference. In this way, not only the physical properties can be evaluated, but also the hand preference or the physiological, psychological and social aspects of the fabric hand.

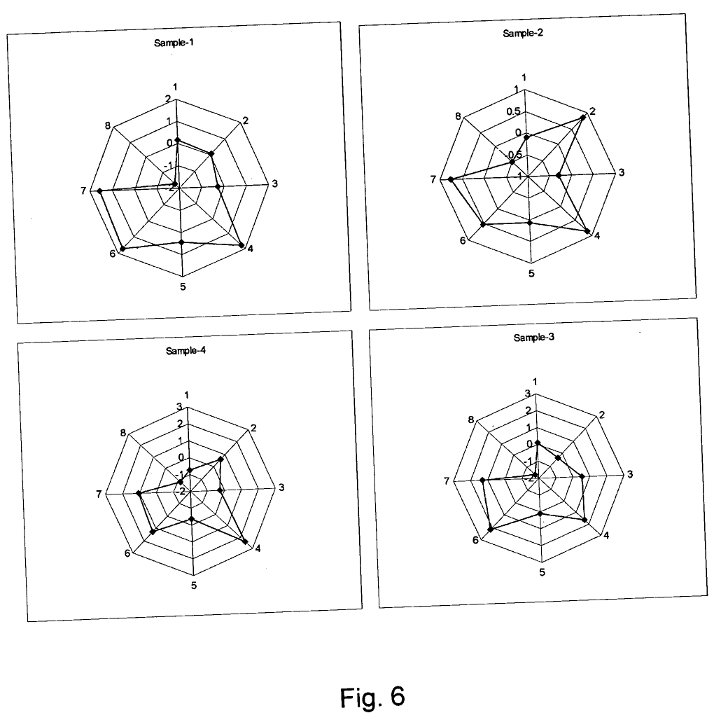

FIG. 6 illustrates exemplary “fingerprints”, or signatures, of different fabrics created by the fabric hand evaluation instrument, in accordance with an embodiment of the present invention. By using the fabric feature set F with its 8, in this example, independent features F₁, F₂ . . . F₈ each reflecting a different aspect of fabric hand, the corresponding fabric can be fingerprinted by using a diagram to represent each fabric. Feature set F is unique to the fabric much in the same way a fingerprint is unique to a person.

A radar diagram is adopted for clarity in the present embodiment with p=8 scaled axes projected outwards from the center with equal angle interval. For a fabric tested, its exemplary 8 features are each located on a corresponding axis. Then by connecting all the location points, a spider-web like diagram is constructed. FIG. 6 illustrates the 4 diagrams for the 4 fabrics in Table 1, respectively. By simply comparing the diagrams, the differences or similarities between the fabrics are clearly and conveniently illustrated. The present technique can be used to evaluate the differences between a new fabric (e.g., from new materials, new processing technology or new surface finishing) and a reference fabric to see how these new methods or materials affect related fabric performance, to what degree, or if the caused changes in fabric performance are too great to be viewed as retaining the same performance as the reference fabric does.

In an embodiment of the present invention, the system can also be used to measure the wrinkle recovery properties of fabrics. A fabric sample tested by this system forms uniform and complex wrinkles with high repeatability. To test the wrinkle recovery properties of a fabric, a fabric sample is tested with the present invention twice with a designated recovery time in between (for example, 5 minutes according to AATCC 66). Then the difference between the RH values of the two tests is calculated as the Wrinkle Recovery Value (WRV). Even the wrinkle recovery differences in terms of stiffness, softness and smoothness are provided.

In another embodiment of the present invention, the system can also be used to measure the drape property of fabrics. The test performed on a fabric sample by the preferred embodiment of the present invention is actually a forced drape test with high repeatability. Comparison of the fingerprints for two fabrics provides evaluation of the drape ability. The difference in the RH values between the two fabrics can be calculated as the Drape Value change (DDV). Even the drape differences in terms of stiffness, softness and smoothness are indicated.

In an alternate embodiment of the present invention, the system can be used to test other materials once a similar curve is generated using the testing device of the system

A novel approach to the problem of fabric hand evaluation has thus been provided by way of the foregoing teachings, and it will be apparent to those skilled in the art how to configure embodiments of the present invention to meet the needs of the particular application. The present embodiment is not only capable of providing a critical quality assurance method for the textile industry, it is contemplated that the present invention will also be useful to any other industries (e.g., consumer product industries) where product quality relies on sensory evaluation. Further, embodiments of the present invention may also be employed to shed light on our understanding of relationship between physical stimuli and physiological, psychological and social response.

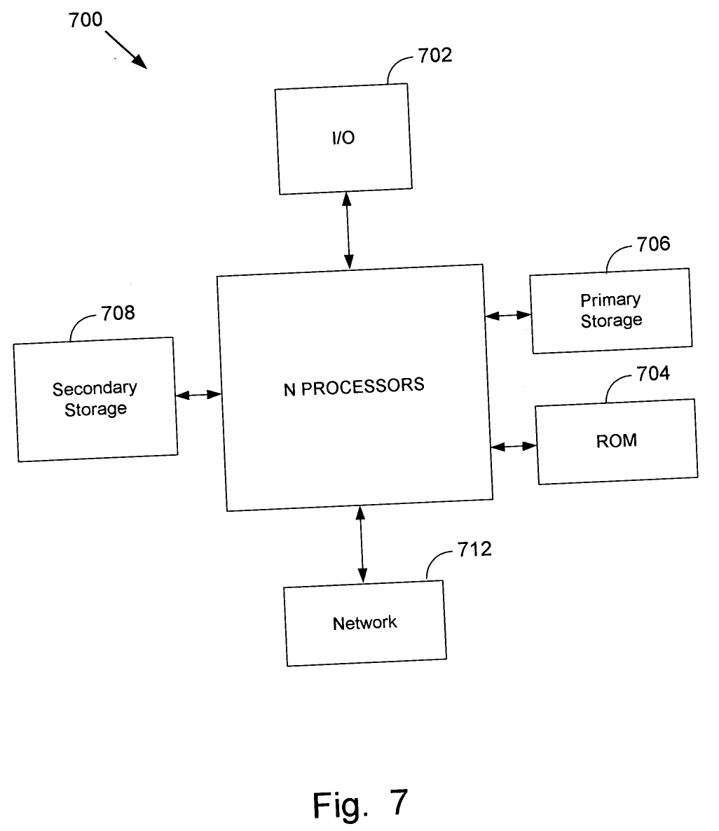

FIG. 7 illustrates a typical computer system that, when appropriately configured or designed, can serve as a computer system in which the invention may be embodied. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., C.P.LDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection as shown generally at 712. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing method steps and/or system components may be suitably replaced, reordered, removed and additional steps and/or system components may be inserted depending upon the needs of the particular application, and that the fabric hand evaluation system of the present embodiment may be implemented using any of a wide variety of suitable processes and system components, and is not limited to any particular computer hardware, software, firmware, microcode and the like.

In light of the foregoing teachings, those skilled in the art will readily recognize how to best implement any of the foregoing system components described depending upon the needs of the particular situation.

Having fully described at least one embodiment of the present invention, other equivalent or alternative methods of implementing fabric hand evaluation according to the present invention will be apparent to those skilled in the art. The invention has been described above by way of illustration, and the specific embodiments disclosed are not intended to limit the invention to the particular forms disclosed. For example, although the foregoing embodiments were directed towards evaluating fabrics, those skilled in the art will readily recognize that the teachings of the present invention may be similarly applied to the evaluation of any suitable material; thus, application of the foregoing teachings to non-fabric applications is contemplated as within the scope of the present invention. The invention is thus to cover all modifications, equivalents, and alternatives falling within the spirit and scope of the following claims.

What is claimed is:

1. Method for evaluation of a material, the method comprising the Steps of:
acquiring initial sensory response data from the material;
performing an Eigen-analysis on the data;
extracting at least one feature from said Eigen-analysis; and
ranking the material based on said at least one feature.

2. The material evaluation method of claim 1, further comprising the step of pre-processing the acquired initial data, said pre-processed data being used by said Eigen-analysis instead of the initial data.

3. The material evaluation method of claim 1, farther comprising the step of establishing a physiological scaling scheme that is used as a basis for said ranking step.

4. The material evaluation method of claim 1, further comprising the step of generating a testing report.

5. The material evaluation method of claim 1, wherein the material is a fabric.

6. The material evaluation method of claim 5, further comprising steps for evaluating the fabric for wrinkle recovery ability.

7. The material evaluation method of claim 5, further comprising steps for evaluating the fabric for fabric drape-ability.

8. The material evaluation method of claim 1, further comprising steps for generating a feature signature unique to the material.

9. The material evaluation method of claim 1, further comprising steps for determining key features of the material.

10. An apparatus for evaluation of a material, the apparatus comprising:
means for acquiring initial sensory response data from the material;
means for evaluating the data; and
means for displaying the results produced by said data evaluation means.

11. The material evaluation apparatus of claim 10, wherein the material is a fabric.

12. The material evaluation apparatus of claim 11, further comprising means for evaluating the fabric for wrinkle recovery ability.

13. The material evaluation apparatus of claim 11, further comprising means for evaluating the fabric for fabric drape-ability.

14. A computer program product for evaluation of a material, the computer program product comprising the Steps of:
computer code that acquires initial sensory response data from the material;
computer code that performs an Eigen-analysis on the data;
computer code that extracts at least one feature from said Eigen-analysis;
computer code that ranks the material based on said at least one feature; and
a computer-readable medium that stores the computer code.

15. The computer program product of claim 14, further comprising computer code that pre-processes the acquired initial data, said pre-processed data being used by said computer code for Eigen-analysis instead of the initial data.

16. The computer program product of claim 14, further comprising computer code that establishes a physiological scaling scheme that is used by said ranking computer code.

17. The computer program product of claim 14, wherein the material is a fabric.

18. The computer program product of claim 17, further comprising computer code that evaluates the fabric for wrinkle recovery ability.

19. The computer program product of claim 17, further comprising computer code that evaluates the fabric for fabric drape-ability.

20. The computer program product according to claim 14 wherein the computer-readable medium is one selected from the group consisting of a data signal embodied in a carrier wave, a CD-ROM, a hard disk, a floppy disk, a tape drive, and semiconductor memory.
